(19) United States
(12) Patent Application Publication
(10) Pub. No.: US 2006/0008402 A1
(43) Pub. Date: Jan. 12, 2006

(54) Method for preparing activated silica for water treatment

(76) Inventor: Antonio T. Robles, Kirkland Lake (CA)

Correspondence Address: Antonio T. Robles, 17 Furlong St., Kirkland Lake, ON, P2N3P5, CA

(21) Appl. No.: 10/887,140

(22) Filed: Jul. 12, 2004

(51) Int. Cl. C01B 33/12

(52) U.S. Cl. 423/338

(57) ABSTRACT

A process is disclosed for the production of activated silica for water treatment. The process acidifies the silicate and uses caustic material to raise the pH to less than 12 to stabilize the activated silica. The process improves the efficiency of the coagulation/flocculation/sedimentation processes used in water treatment.

### CROSS REFERENCES TO RELATED APPLICATIONS

Not Applicable

### BACKGROUND—FIELD OF INVENTION

This invention relates to the production of activated silica (AS) used for water treatment, specifically to an improved production process.

### BACKGROUND—DESCRIPTION OF PRIOR ART

Coagulation and flocculation is the most common method in potable water treatment to remove particulate and soluble impurities. These impurities may be mineral or organic in origin.

Colloidal particles are removed using coagulating chemicals, such as, alum and ferric salts. The chemical coagulants neutralize the electrical charges of the particles that cause them to clump together. These coagulants form metal hydroxides that can adsorb on particles together to form a floc.

Flocculation is the agglomeration of destabilized particles into microfloc, and later into bulky floccules that can be settled called floc. The introduction of another reagent, called a flocculant or a flocculant aid may promote the formation of the floc. The flocculation process provides contact between particles to promote their gathering together into a floc and removal by sedimentation and filtration.

Inorganic polymers (activated silica) and natural polymers (starches, alginate) were the first flocculant to be used. Later synthetic polymers became popular due to ease of use.

Activated silica was the first flocculant used. It gives good results, especially when used together with alum in cold water. It is generally added after the coagulant and is prepared immediately before use by partially neutralizing the alkalinity of a solution of sodium silicate. Activated silica is prepared in alkaline conditions [1].

There is not one type of activated silica but an infinity of silicas, the behavior of which cannot be foreseen, especially as surface chemistry is an important characteristic of activated silica that significantly affects their chemical and physical properties.

When producing activated silica, it is necessary to consider a large number of parameters affecting the characteristics of the final product, such as the activating agent, the concentration of various reactants, pH, reaction time and temperature, and the way the reagents are mixed [2]. Attempts have long been made to isolate the various chemical reactions involved in the formation of activated silica and their effect on the final product. Baylis, J. R, U.S. Pat. No. 2,217,466, for instance, discloses forming activated silica by partial neutralization of alkali metal silicate by the addition of a N/50 of sulfuric acid to a 1 to 3 percent silicate solution. The aging concentration of silica in the mixture is about 1.5% and the final concentration before use is 1% by dilution with water. About 85% of the sodium silicate in the batch preparation is neutralized by the acid and requires an aging time of about one hour before use. This method of making activated silica is difficult to accomplish due to gelling and long aging time. This method suffers from the disadvantage that the making of the activated silica requires close control of alkalinity for best results.

Schworm et al., U.S. Pat. No. 2,234,285, tried to use sulfate salts, such as aluminum and iron sulfate instead of sulfuric acid to partially neutralize sodium silicate. The mixture is added into the water without aging the activated silica. Baker et al., U.S. Pat. No. 2,310,009 improved the use of metal salts by aging the activated silica to incipient gel formation and then diluting it with water to stabilize the activated silica. This method suffers from the disadvantage that the making of the activated silica requires higher reagent cost.

Hay et al., U.S. Pat. No. 2,444,774, tried to use ammonium sulfate to make activated silica with the advantage that the product is not prone to gelling. This may be advantageous to water treatment plants that use chloramine as the primary disinfectant. This method suffers from the disadvantages of expensive reagents and ammonia added to the water may not be wanted in the finish product.

Walker, J. D., U.S. Pat. No. 2,769,785, tried to use chlorine to make activated silica that lends to continuous type of operation. This method suffers from the disadvantages of complex apparatus and control of the activated silica making process. This process is complicated to implement.

Elston, J. W., U.S. Pat. No. 2,466,842, Mahler, W., U.S. Pat. No. 4,213,950, and Arika et al., U.S. Pat. No. 4,554,211, demonstrated the production of silica gel that is unsuitable as a flocculant in the water treatment process.

Rushmere U.S. Pat. No. 4,954,220 and No. 5,176,891 showed the benefits of using different activating agents for the production of activated silica use in papermaking retention and drainage.

In prior art, attempts to design an activated silica preparation systems suffered from lack of connection between the chemistries of the activated silica preparation and its effects on the coagulation/flocculation processes.

The most common activating agents are: sulfuric acid, alum, chlorine, sodium bicarbonate, carbon dioxide, and sodium aluminate. Among these agents sulfuric acid is the cheapest.

The applications of activated silica depend mainly on the size, charge, and shape of the polymer. During the aging period the monomer, dimer, or low molecular weight polymer of silicic acid formed on neutralization of the silicate alkalinity by acidic material increases in size. The mixture gels if the aging process is not stopped by dilution, addition of alkali or other means. The size of the activated silica polymer can be varied over a wide range by controlling the aging time. The charge of the polymer may be varied by changing the pH or by forming the polymer in the presence of ions and molecules that are adsorbed. This changes the chemical/physical properties of the polymer.

In summary, prior methods of making activated silica called for:
(a) A close control of alkalinity, such as the Baylis method;
(b) The use of relatively expensive activating reagent, such as sulfate salts;
(c) The use of gases such as carbon dioxide, chlorine, and sulfur dioxide that can cause asphyxiation; or
(d) Relatively long aging time.

These prior methods had the following disadvantages:
(a) Requires close monitoring of the preparation process;
(b) Higher cost;
(c) Frequent maintenance due to failed or gelled silica;
(d) Close monitoring for gas (chlorine, carbon dioxide, sulfur dioxide) leaks;
(e) Long aging time; or
(f) Poor quality control in the manufacture of activated silica.

Thus, there is a need for a fast, safe, low cost, and efficient process for making activated silica solutions. My invention fills that need.

### SUMMARY

The present invention shows a better way of making activated silica by complete neutralization and acidification of the silicate using mineral acid and then raising the pH using caustic substances. Choosing the end-point pH after acid and/or caustic addition determines the type of activated silica produced. This is very advantageous since there are many types of raw water of different chemical and physical characteristics that may require specific type of activated silica for effective treatment.

### OBJECTS AND ADVANTAGES

Accordingly, besides the objects and advantages in the preparation process for activated silica described in my above patent, several objects and advantages of the present invention are:
(a) provides a fast and efficient preparation process;
(b) provides a preparation process that is simpler and cheaper to operate than existing processes;
(c) provides a preparation process that can be easily adapted to existing processes;
(d) provides a preparation process free of the hazards associated with the use of asphyxiating gasses;
(e) provides a preparation process that can be tailored to different kinds of raw water;
(f) provides a preparation process that can use commonly available acid; and
(g) provides a more active and stable activated silica.

The description and drawings below show additional objects and advantages.

### BRIEF DESCRIPTION OF THE DRAWINGS

FIG. 1 shows the major components and flow directions of my activated silica preparation process.

FIG. 2 shows the schematic of the water treatment plant where this invention was developed and in use.

### REFERENCE NUMERALS

Not Applicable

### PREFERRED EMBODIMENT

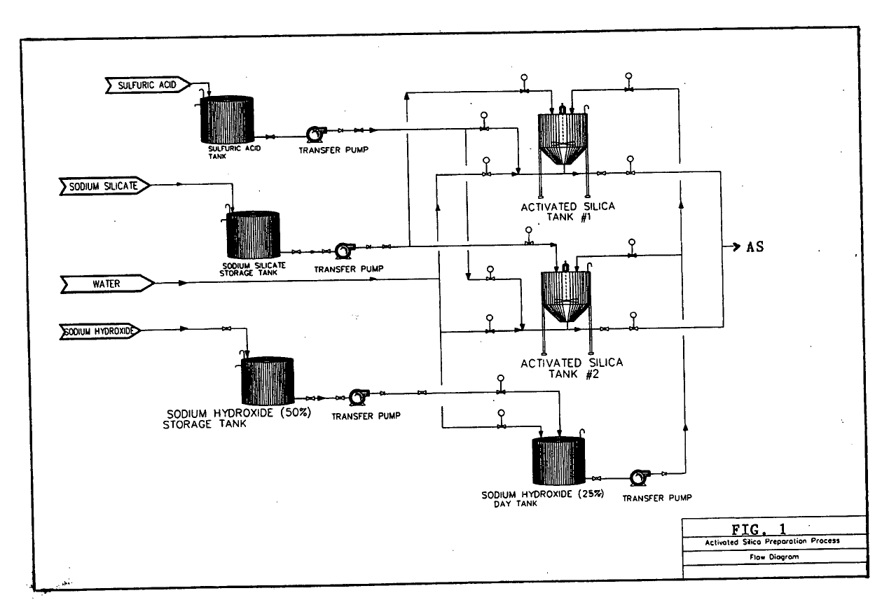

A preferred process involving selected major operations is shown in FIG. 1.

Activated Silica is produced and stored in two (2) batching/storage tanks, made of High Density Cross-Linked Polyethylene. The liquid level in each tank is monitored by an ultrasonic level transmitter with the value read-out available locally at the transmitter and at the main SCADA computer. The tanks have an empty volume of five cubic meters and can hold a four cubic meter batch.

Activated Silica is generated in batching tanks in accordance with the following sequence:

| Step No. | What to do. |
|---|---|
| 1 | Open water line and fill batching tank with water |
| | until total volume is 2 000 liters. |
| 2 | Add 100 litres of Sodium Silicate with mixer |
| | operating at full speed. |
| 3 | Open water supply line and pump 15 litres of 93% |
| | sulfuric acid into water line while water is added |
| | to the tank. Continue water addition until total |
| | volume in the tank is 3 000 liters. Mixer is at |
| | high speed. |
| 4 | Pump 11.5 liters of 25% sodium hydroxide. Mixer |
| | is at high speed. |
| 5 | Add water until the total volume in the tank is |
| | 4 000 liters. Mixer is at high speed. |
| 6 | Shutdown mixer. AS batch is ready for use. |

The following is typical timeline for the batching process. Not included in the estimated time is the extra 5 minutes mixing time after each step to make sure the mixture is homogenous before proceeding to the next step.

The volume of ingredients added to the batch is measured using “Milltronics” liquid level sensor. Water and sodium silicate volumes are measured using the AS batch tank sensor, while the acid and caustic volumes are measured using their respective “day” tank sensor.

| Step No. | Notes |
|---|---|
| 1 | Estimated time: 13 minutes at 150 L/min water |
| | addition rate. The water is added at the bottom of |
| | the tank and mixed with leftover activated silica |
| | from the previous batch. It is advisable to keep |
| | the volume of leftover activated silica to a |
| | minimum (<5% of the finished batch volume). |
| 2 | Estimated time: 15 to 35 minutes. The time |
| | required to add 100 litres of sodium silicate, |
| | depends on pump capacity and viscosity of the |
| | silicate. The silicate is added through the top |
| | of the tank to prevent it from contacting acidic |
| | solution that will cause gelling. The silicate |
| | should be stored at all times above 23 degrees |
| | Centigrade to keep the silicate fluid enough to |
| | pump. After silicate addition, the batch pH is |
| | greater than 11 and SiO₂ concentration of about 2%. |
| 3 | Estimated time: 5 minutes The water supply is |
| | first opened and after 1 minute the concentrated |
| | acid is injected into the water line for dilution |
| | and mixing before it comes in contact with the |
| | silicate solution inside the batch tank. The |
| | agitator provides vigorous mixing of the acid and |
| | silicate solution. After acid addition the pH of |
| | the batch is about 1.8 to 2.5, SiO₂ concentration |
| | about 1.5% |
| 4 | Estimated time: 2 minutes. Like the silicate, |
| | the 25% caustic solution is added through the top |
| | of the tank. After caustic addition the pH of the |
| | batch should be about 8.5 to 10.5. |
| 5 | Estimated time: 7 minutes Add water until the |
| | total volume in the tank is 4 000 liters. SiO₂ |
| | concentration about 1%. |
| 6 | Shutdown mixer and batch is ready for use. |

The above procedure of making activated silica use sodium hydroxide to raise the pH from about 2 to <10.5. Alternatively, the caustic may be added after the dilution water.

In my method, the polymerization process takes place in a short time period. It requires same or less space and equipment than in a continuous process. Some disadvantages of the continuous process are:
(a) In a continuous production of activated silica, at least two storage tanks are required to hold diluted silicate and acid solutions.
(b) The diluted acid and silicate has to be metered with each other to achieve the right ratio and at the same time to the raw water flow.
(c) Diluted silicates will start polymerizing as soon as it is diluted and stored in a storage tank. The quality of the diluted silicate solution will degrade and will produce activated silica of variable activity.
(d) The strength of the acid and silicate solutions when mixed determines the quality of the activated silica and gelling time. Precipitation of activated silica cause high maintenance cost.

Unlike the continuous preparation process, the batch process is more reliable because of redundancy of having two batch/storage tanks. The batch preparation process is automated via SCADA computer control.

### EXAMPLE

Standard conditions using sodium hydroxide to raise the pH of the batch:
(a) Activated silica concentration of 1% SiO₂ before use.
(b) The activated silica final solution pH of 8.5 to 10.5.
(c) The silicate was acidified to pH of 1.8 to 2.2 before 11.5 L sodium hydroxide (25%) was added.
(d) Activated silica concentration of 1.5% SiO₂ before final dilution with water to 1% SiO₂.

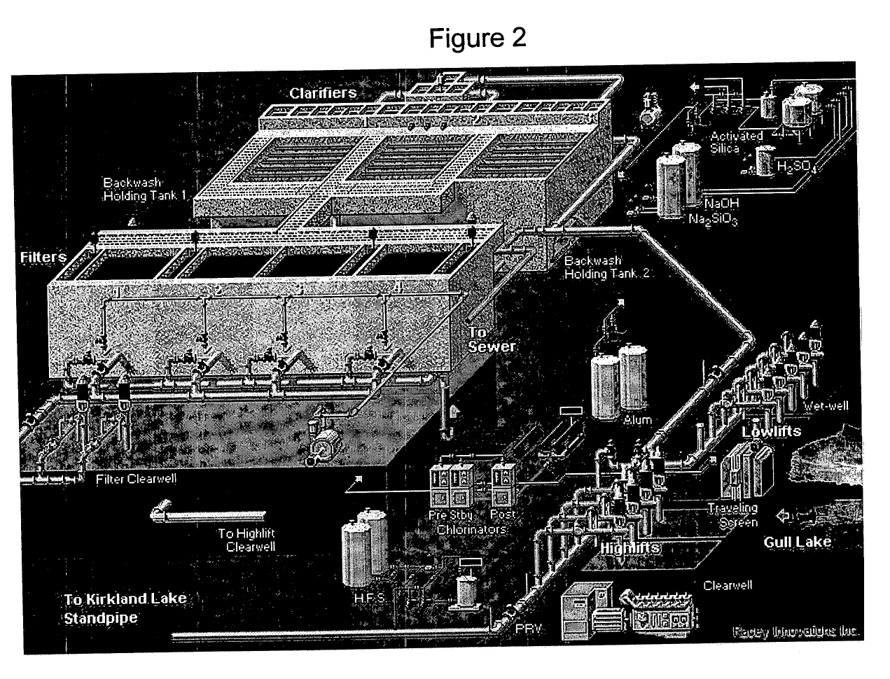

The activated silica solution prepared above was added to raw water for treatment at a rate of about 2.5 to 4 ppm silica. Alum at 30 to 40 ppm was added to raw water ahead of the activated silica. FIG. 2 shows the schematic of the water treatment plant where the activated silica produced by this new process was tested and proven to significantly improve coagulation, flocculation and clarification of the treated water.

The plant has a particle monitor in addition to turbidity meters that show improved water quality coming out of the filters. The activated silica produced by the process of this invention consistently produced filtered water with very low turbidities and particle content.

### ALTERNATIVE EMBODIMENT

There are various possibilities with regard to the addition of caustic. The neutralization of the batch from about pH 2 to pH <12 with caustic may be accomplish before or after the final dilution water. For example, after acid addition, the batch may be diluted to the final volume (say 4000 L) before caustic material such as sodium hydroxide or sodium silicate or both is added to raise the pH to <12.

When using sodium hydroxide only, the batch pH should be held below 10.5 because the activated silica will start to depolymerize above 10.5 in the absence of sodium silicate.

The alkali silicate added after acid addition improves the stability of the AS. It is preferable to add this silicate after the batch has been diluted with water. This preparation process produces more stable activated silica that is suitable for a wide variety of raw waters for treatment.

The activated silica produced by my method does not readily form precipitates because the high final of pH 8.5 to 12. The high salt (sodium sulfate) content improves the activity.

### CONCLUSIONS, RAMIFICATIONS, AND SCOPE

It is clear that activated silica produced by my method enhances the removal of impurities in raw water. My method of preparing activated silica extends present knowledge of activated silica chemistry. Furthermore, my method has additional advantages over prior art in that:
it allows the use of low cost and commonly available reagents;
it allows the production of a more active and stable activated silica;
it provides a fast preparation process of the activated silica;
it provides low maintenance on equipment due to less precipitation or gelling of the activated silica; and
it provides an effective means of removing impurities in raw water.

The specific data in the examples described above are merely illustrative; they do not limit the scope of the invention. Various ramifications are possible within the scope of the invention. For example, although the optimum acid pH of about 2 was used in this particular water treatment plant, other water treatment plant may have optimum pH between 1.5 and 7 before caustic addition. Likewise, an endpoint pH from 8.5 to 12 may be used after caustic addition.

Other caustic material such as soda ash, alkali silicates, and lime may be used instead of sodium hydroxide recommended by my method. The advantage of using soda ash is it also adds alkalinity to the water where additional alkalinity is beneficial. Likewise, other acid material such as other mineral acid and its salts may be used to lower the silicate to an acid pH.

Thus, the scope of the invention should be determined by the appended claims and their legal equivalents, rather than by the examples given.

I claim:

1. A process for producing activated silica by acidifying a solution of alkali silicate and then adding caustic material to a basic pH to stabilize the activated silica.

2. The process of claim 1 wherein said acidifying is done to a pH of 1.5 to 6.5 with mineral acid.

3. The process of claim 2 wherein said mineral acid is sulfuric acid.

4. The process of claim 2 wherein said pH is preferably 1.5 to 3.5.

5. The process of claim 1 wherein said alkali silicate is sodium silicate.

6. The process of claim 5 wherein said sodium silicate has a molar ratio of SiO₂ to Na₂O of 3.22.

7. The process of claim 1 wherein said caustic is selected from the group consisting of, soda ash, alkali silicate, potassium hydroxide, calcium hydroxide or oxide, or preferably sodium hydroxide.

8. The process of claim 1 wherein said basic pH is from 8.5 to 12.
